(19) United States
(12) Patent Application Publication
(10) Pub. No.: US 2013/0072254 A1
(43) Pub. Date: Mar. 21, 2013

(54) Universal Coil Antenna Having Respective Portions Thereof Associated with Different Functional Modules

(71) Applicant: Peter Körner, Lund (SE)

(72) Inventor: Peter Körner, Lund (SE)

(73) Assignee: Sony Ericsson Mobile Communications AB

(21) Appl. No.: 13/237,475

(22) Filed: Sep. 20, 2011

(51) Int. Cl. H04W 88/02; H01Q 7/00

(52) U.S. Cl. 455/552.1; 343/866

(57) ABSTRACT

An antenna used for receiving signals for a plurality of functional modules in an electronic devices includes a single coil including a first portion associated with a first one of the functional modules and a second portion associated with a second one of the functional modules.

### BACKGROUND

The present invention relates to antennas and, more particular, to antennas used in electronic devices, such as mobile terminals.

Electronic devices, such as mobile terminals, are made with increasingly smaller dimensions. Moreover, the functionality provided by such devices is generally increasing over time. Many of the functions and features typically use a dedicated antenna or interface coil. The existence of multiple antennas or coils in a device, however, can consume a significant amount of space, which is often in short supply in newer devices. Moreover, the multiple antennas or coils may create performance issues in a device due to electromagnetic interference or other coexistence problems.

### SUMMARY

According to some embodiments of the present invention an antenna used for receiving signals for a plurality of functional modules in an electronic devices comprises a single coil comprising a first portion associated with a first one of the functional modules and a second portion associated with a second one of the functional modules.

In other embodiments, the first portion of the single coil comprises a plurality of taps.

In still other embodiments, the first portion of the single coil is disposed around a core material.

In still other embodiments, the antenna further comprises a first terminating impedance coupled to the first portion of the single coil that is associated with the first one of the functional modules and a second terminating impedance coupled to the second portion of the single coil that is associated with the second one of the functional modules.

In still other embodiments, the antenna further comprises a variable capacitor bank coupled to the single coil.

In still other embodiments, the first one of the functional modules comprises a wireless charging functional module.

In still other embodiments, the first one of the functional modules comprises a Near Field Communication (NFC) functional module.

In still other embodiments, the first one of the functional modules comprises an Amplitude Modulation (AM) radio functional module.

In still other embodiments, the first one of the functional modules comprises a Frequency Modulation (FM) radio functional module.

In still other embodiments, the first one of the functional modules comprises a hearing assistance functional module.

In still other embodiments, the first one of the functional modules comprises a standard low frequency and time code signal functional module.

In further embodiments of the present invention, an electronic device comprises a plurality of functional modules, a single coil comprising a plurality of portions associated with respective ones of the plurality of functional modules, and a switching network that is operable to connect the plurality of functional modules to the plurality of portions of the single coil, respectively.

In still further embodiments, the electronic device further comprises a variable capacitor bank coupled to the single coil.

In still further embodiments, one of the plurality of functional modules comprises a wireless charging functional module.

In still further embodiments, one of the plurality of functional modules comprises a Near Field Communication (NFC) functional module.

In still further embodiments, one of the plurality of functional modules comprises an Amplitude Modulation (AM) radio functional module.

In still further embodiments, one of the plurality of functional modules comprises a Frequency Modulation (FM) radio functional module.

In still further embodiments, one of the plurality of functional modules comprises a hearing assistance functional module.

In still further embodiments, one of the plurality of functional modules comprises a standard low frequency and time code signal functional module.

In still further embodiments, the electronic device is a mobile terminal.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a diagram of an electronic device that is configured to transmit and/or receive wireless signals with a wireless station using an antenna in accordance with some embodiments of the present invention;

FIG. 2 is a block diagram that illustrates an electronic device/mobile terminal in accordance with some embodiments of the present invention;

FIG. 3 is a circuit diagram that illustrates an antenna in accordance with some embodiments of the present invention; and

FIG. 4 is as block diagram that illustrates the connection between an antenna and a plurality of functional modules in accordance with some embodiments of the present invention.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

For purposes of illustration, embodiments of the present invention are described herein in the context of a mobile terminal. It will be understood, however, that the present invention is not limited to such embodiments and may be embodied generally as an electronic device that is configured to establish connections with one or more peripheral devices or accessories.

Some embodiments of the present invention arise from a realization that if many of the functions in an electronic device, such as a mobile terminal, are assigned their own antenna or coil, then valuable space inside the device could be taken up with the multiple antennas or coils and/or the multiple antennas or coils could create performance problems for a device due to electromagnetic interference or other coexistence issues. Some embodiments of the present invention provide an antenna that comprises a single universal coil where portions of the coil are associated with various functionality provided in an electronic device. Such a design may save space, reduce component count, and/or reduce coexistence issues that may be seen with separate antennas dedicated to individual functions.

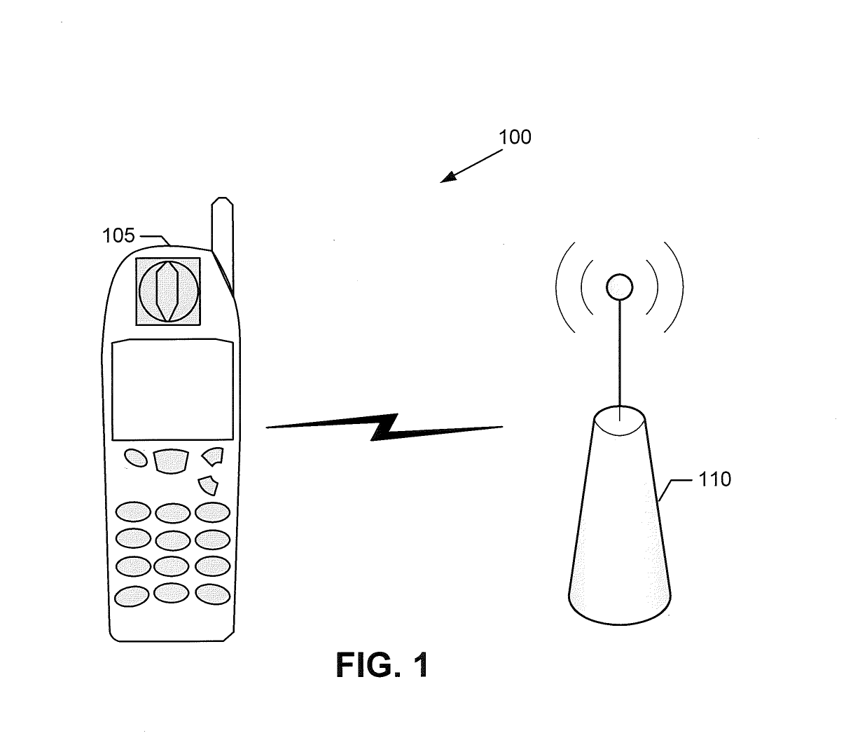

FIG. 1 is a diagram of an electronic device 105 that is configured to transmit and/or receive wireless signals with a wireless station 110 using an antenna in accordance with some embodiments of the present invention. The electronic device 105 includes an antenna that comprises a single universal coil where portions of the coil are associated with various functionality provided in an electronic device 105.

Although FIG. 1 illustrates exemplary communication between an electronic device 105 and a wireless station 110, it will be understood that the present invention is not limited to such configurations, but is intended to encompass any configuration capable of carrying out the operations described herein.

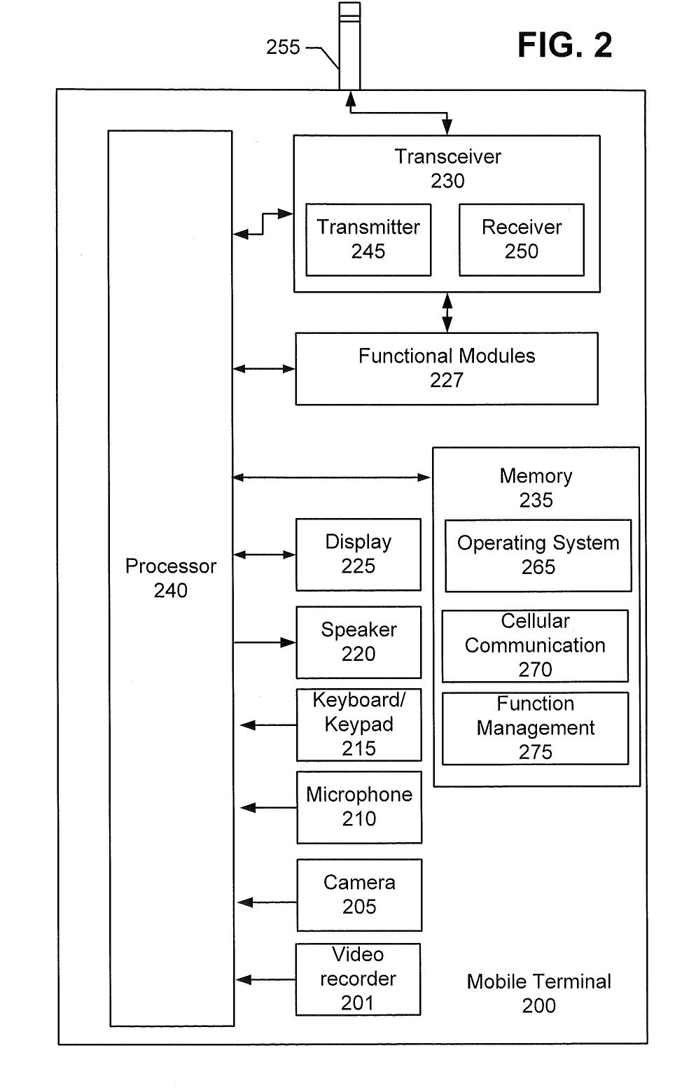

Referring now to FIG. 2, an exemplary mobile terminal 200 that may be used to implement a device, such as the electronic device 105 of FIG. 1, in accordance with some embodiments of the present invention, includes a video recorder 201, a camera 205, a microphone 210, a keyboard/keypad 215, a speaker 220, a display 225, a transceiver 230, and a memory 235 that communicate with a processor 240. The transceiver 230 comprises a transmitter circuit 245 and a receiver circuit 250, which respectively transmit outgoing radio frequency signals to base station transceivers and receive incoming radio frequency signals from the base station transceivers via an antenna 255. The radio frequency signals transmitted between the mobile terminal 200 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information.

The foregoing components of the mobile terminal 200 may be included in many conventional mobile terminals and their functionality is generally known to those skilled in the art.

The mobile terminal also includes a plurality of functional modules 227 that provide various functionality and features that conventionally may be associated with a dedicated antenna or coil. According to some embodiments of the present invention, the functional modules 227 are respectively associated with portions of a universal coil that is used to implement the antenna 255.

The processor 240 communicates with the memory 235 via an address/data bus. The processor 240 may be, for example, a commercially available or custom microprocessor. The memory 235 is representative of the one or more memory devices containing the software and data used to operate the mobile terminal 200 as well as to operate the functional modules 227 that are respectively associated with portions of the single coil comprising the antenna 255. The memory 235 may include, but is not limited to, the following types of devices: cache, ROM, PROM, EPROM, EEPROM, flash, SRAM, and DRAM.

As shown in FIG. 2, the memory 235 may contain three or more categories of software and/or data: the operating system 265, a cellular communication module 270, and/or a function management module 275. The operating system 265 generally controls the operation of the mobile terminal 200. In particular, the operating system 265 may manage the mobile terminal's software and/or hardware resources and may coordinate execution of programs by the processor 240. The cellular communication module 270 may be configured to manage the cellular communication protocols that are used to allow the mobile terminal 200 to communicate with other devices and systems. The function management module 275 may be configured to manage the various function and features provided through the functional modules 227. These functions/features may include, but are not limited to, a wireless charging module, a Near Field Communication (NFC) module, an Amplitude Modulation (AM) radio module, a Frequency Modulation (FM) radio module, a hearing assistance module, and a low frequency/time code signal module.

Although FIG. 2 illustrates an exemplary software and hardware architecture that may be used by an electronic device, such as a mobile terminal, in which an antenna is implemented through a single universal coil comprising multiple portions associated with multiple functional modules, respectively, in accordance with some embodiments of the present invention, it will be understood that the present invention is not limited to such a configuration, but is intended to encompass any configuration capable of carrying out the operations described herein.

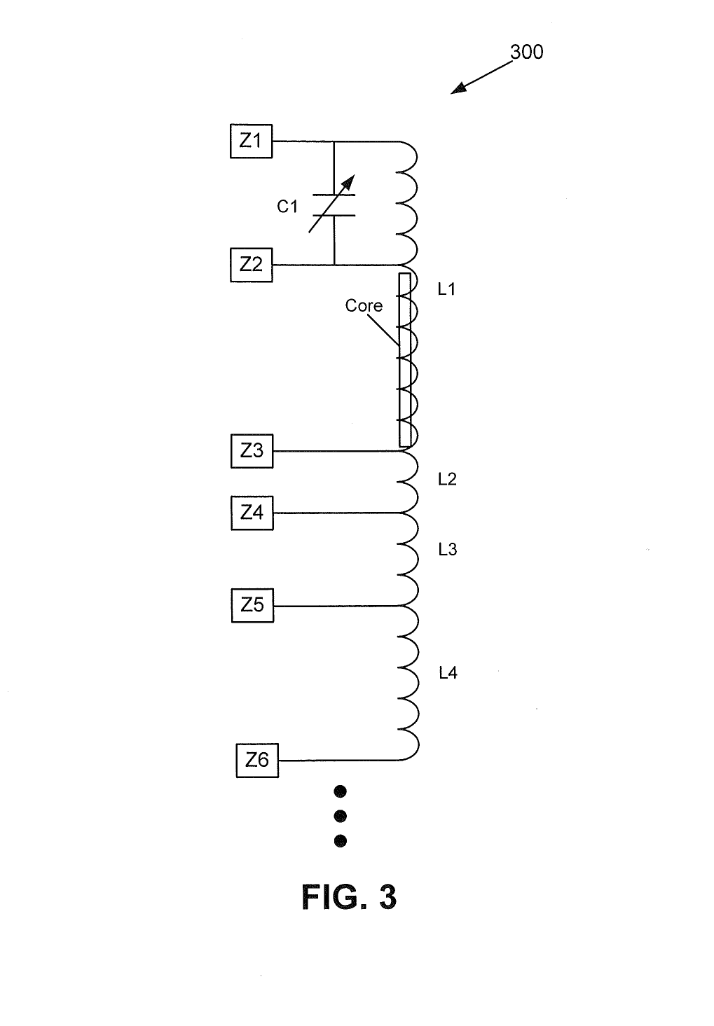

FIG. 3 is a circuit diagram that illustrates an antenna 300 in accordance with some embodiments of the present invention. As shown in FIG. 3, the antenna 300 comprises a single coil that is divided into multiple portions L1, L2, L3, and L4 using a plurality of taps. The different portions of the coil may be associated with the respective functional modules 227 of FIG. 2. Each portion of the coil may, therefore, be tailored to implement the particular function or feature with which it is associated. For example, the number of windings in a particular coil section, whether or not a core section is used to carry the windings, the type of core material used, the particular impedance Z1-Z6 used to terminate the taps, whether a tuning capacitor C1 is used, and the like may be configured to best implement the particular function or feature. Any tap could be connected, permanently or momentarily, to ground.

In some embodiments, a wireless charging module may use the entire coil and operate at a frequency of about 100 kHz, an NFC module may use a portion of the coil configured to operate at a frequency of about 13.56 MHz, an AM radio module may use a portion of the coil configured to operate at frequencies between about 150 kHz and 1700 kHz, an FM radio module may use a portion of the coil configured to operate at frequencies between about 76 MHz and 108 MHz, a hearing assistance module may use the entire coil and operate at audio frequencies, and standard low frequency/time code signal module may use the entire coil and operate at a frequency about 40 kHz-80 kHz.

In general for functions or features using higher frequencies and requiring a higher Quality (Q) factor, only a part of the coil with suitable inductance for high Q tuning is used. In some embodiments, the coil could be used as an autotransformer to enhance Q while picking the signal at the number of windings where the impedance is well matched. In the example shown in FIG. 3, the tap represented by impedance Z2 may be a variable tap where the number of windings is selected along the portion L1 and variable capacitor turning through capacitor C1 is used to fine tune the coil portion to a particular frequency. The multiple taps may be terminated using impedance values Z1-Z6 to match the impedance of the particular functional module 227 with which a particular coil portion L1-L4 is associated. This may reduce loss in communicating signals between the particular functional module 227 and the associated coil portion L1-L4.

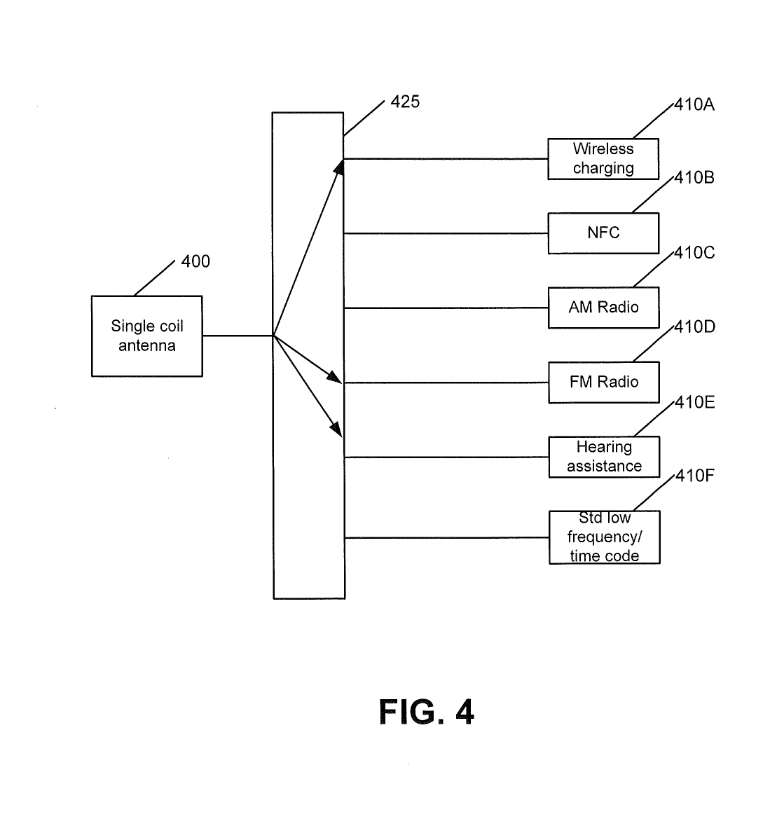

FIG. 4 is as block diagram that illustrates the connection between an antenna and a plurality of functional modules in accordance with some embodiments of the present invention. A single coil antenna 400, such as the antenna 300 of FIG. 3, may have respective portions thereof coupled to a plurality of functional modules 410 using a switching network 425. The functional modules may include, but are not limited to, a wireless charging module 410A, an NFC module 410B, an AM radio module 410C, an FM radio module 410D, a hearing assistance module 410E, and a standard low frequency/time code signal module 410F. In accordance with various embodiments of the present invention, the switching network 425 may be operable to connect only one of the functional modules 410 to its associated portion of the single coil antenna 400 at a time. In other embodiments, however, where some functional modules are sufficiently separated in operating frequency and/or power the switching network 420 may couple multiple ones of the functional modules 410 to associated portions of the single coil antenna 400 at the same time.

Some embodiments of the present invention may provide an antenna that comprises a single coil with portions thereof associated with various functional modules that provide various features of the electronic device that require an antenna. In contrast with conventional approaches where a dedicated antenna or coil is provided to each functional module, a single, universal coil approach may reduce space in the electronic device, may reduce the number of components used to implement the antenna function, and may improve performance by avoiding electromagnetic interference that can result from separate antennas and coils.

Many variations and modifications can be made to the embodiments without substantially departing from the principles of the present invention. All such variations and modifications are intended to be included herein within the scope of the present invention, as set forth in the following claims.

1. An antenna for receiving signals for a plurality of functional modules in an electronic device, comprising:
a single coil comprising a first portion associated with a first one of the functional modules and a second portion associated with a second one of the functional modules;
wherein the single coil is continuous through the first and second portions.

2. The antenna of claim 1, wherein the first portion of the single coil comprises a plurality of taps.

3. The antenna of claim 1, wherein the first portion of the single coil is disposed around a core material,

4. The antenna of claim 1, further comprising:
a first terminating impedance coupled to the first portion of the single coil that is associated with the first one of the functional modules; and
a second terminating impedance coupled to the second portion of the single coil that is associated with the second one of the functional modules.

5. The antenna of claim 1, further comprising:
a variable capacitor bank coupled to the single coil.

6. The antenna of claim 1, wherein the first one of the functional modules comprises a wireless charging functional module.

7. The antenna of claim 1, wherein the first one of the functional modules comprises a Near Field Communication (NFC) functional module.

8. The antenna of claim 1, wherein the first one of the functional modules comprises an Amplitude Modulation (AM) radio functional module.

9. The antenna of claim 1, wherein the first one of the functional modules comprises a Frequency Modulation (FM) radio functional module.

10. The antenna of claim 1, wherein the first one of the functional modules comprises a hearing assistance functional module.

11. The antenna of claim 1, wherein the first one of the functional modules comprises a standard low frequency and time code signal functional module.

12. An electronic device, comprising:
a plurality of functional modules;
a single coil comprising a plurality of portions associated with respective ones of the plurality of functional modules; and
a switching network that is operable to connect the plurality of functional modules to the plurality of portions of the single coil, respectively;
wherein the single coil is continuous through the plurality of portions.

13. The electronic device of claim 12, further comprising:
a variable capacitor bank coupled to the single coil.

14. The electronic device of claim 12, wherein one of the plurality of functional modules comprises a wireless charging functional module.

15. The electronic device of claim 12, wherein one of the plurality of functional modules comprises a Near Field Communication (NFC) functional module.

16. The electronic device of claim 12, wherein one of the plurality of functional modules comprises an Amplitude Modulation (AM) radio functional module.

17. The electronic device of claim 12, wherein one of the plurality of functional modules comprises a Frequency Modulation (FM) radio functional module.

18. The electronic device of claim 12, wherein one of the plurality of functional modules comprises a hearing assistance functional module.

19. The electronic device of claim 12, wherein one of the plurality of functional modules comprises a standard low frequency and time code signal functional module.

20. The electronic device of claim 12, wherein the electronic device is a mobile terminal.
